(19) United States
(12) Patent Application Publication
(10) Pub. No.: US 2006/0059933 A1
(43) Pub. Date: Mar. 23, 2006

(54) Heating, cooling and ventilation system for a vehicle seat

(75) Inventors: Dmitri Axakov, Windsor (CA); Goran Bajic, Windsor (CA); Marinko Lazanja, Windsor (CA); Boris Zlotin, Southfield, MI (US); Peter Ulan, Southfield, MI (US); Vladimir Gerasimov, Southfield, MI (US); Vladimir Proseanic, Southfield, MI (US)

Correspondence Address: DOBRUSIN & THENNISCH PC, 29 W LAWRENCE ST, SUITE 210, PONTIAC, MI, 48342, US

(73) Assignee: W.E.T. Automotive Systems AG

(21) Appl. No.: 11/232,172

(22) Filed: Sep. 21, 2005

Related U.S. Application Data
(60) Provisional application No. 60/611,893, filed on Sep. 21, 2004.

(51) Int. Cl. B60H 1/32; F25B 15/00; F25B 27/00

(52) U.S. Cl. 62/244; 62/476; 62/238.3

(57) ABSTRACT

The present invention relates to a vehicle seat with a ventilated component such as a seat component or a backrest component, where at least one of the components has a seat cushion and a trim surface. The invention also includes an absorption refrigeration system having a boiler in thermal contact with a heat source of the vehicle, a condenser, and an evaporator located in thermal contact with the vehicle seat. The absorption refrigeration system also includes a conduit fluidity connecting each of the boiler, condenser and evaporator to each other. A refrigerant is located in the conduit and circulates among the components to facilitate temperature conditioning of the vehicle seat.

### CLAIM OF PRIORITY

The present application claims the benefit of provisional application 60/611,893, filed on Sep. 21, 2004, which is hereby incorporated by reference.

### FIELD OF THE INVENTION

The present invention relates generally to heating, cooling and ventilation systems for a vehicle seat and more particularly to a system the uses waste or environmental energy to provide heating, cooling and/or ventilation to a vehicle seat.

### BACKGROUND OF THE INVENTION

Market forces have created a need for cost effective and energy efficient systems for heating, cooling or ventilating of transportation vehicles, and particularly the passenger compartments of vehicles. Known systems include compartment wide systems and well as localized system that provide temperature control or ventilation more directly to the vehicle operators and passengers. Exemplary localized systems include comfort systems that heat, cool or ventilate portions of seats in the vehicle. Seat comfort systems may be tied into the HVAC system of the vehicle or may be self contained in that heating, cooling or ventilation may be provided by components not connected to the HVAC system and mainly located in or around the seat. Known systems, however, while cost effective, increase the energy demands on the vehicle. While these energy demands can be reduced through increased efficiency of the components, additional reductions in energy demands are desirable.

The present invention overcomes one or more of these problems.

### SUMMARY OF THE INVENTION

The present invention relates to a vehicle seat with a ventilated component such as a seat component or a backrest component, where at least one of the components has a seat cushion and a trim surface. The invention also includes an absorption refrigeration system having a boiler in thermal contact with a heat source of the vehicle, a condenser, and an evaporator located in thermal contact with the vehicle seat. The absorption refrigeration system also includes a conduit fluidity connecting each of the boiler, condenser and evaporator to each other. A refrigerant is located in the conduit and circulates among the components to facilitate temperature conditioning of the vehicle seat.

### BRIEF DESCRIPTION OF THE DRAWINGS

In the drawings:

FIG. 1 schematically illustrates one embodiment of the absorption refrigeration system of the present invention.

FIG. 2 schematically illustrates the cooling cycle of one embodiment of the absorption refrigeration system of the present invention.

FIG. 3 schematically illustrates the heating cycle of one embodiment of the absorption refrigeration system of the present invention.

FIG. 4 schematically illustrates the idle cycle of one embodiment of the absorption refrigeration system of the present invention.

FIG. 5 illustrates an interior view of an evaporator.

FIG. 6 illustrators an evaporator combined with an air mover.

FIG. 7 illustrates a cut away view of an evaporator combined with a heat sink, a cold accumulator and covered with insulation.

FIG. 8 illustrates a vehicle seat with an evaporator (inset).

### DETAILED DESCRIPTION

The present invention relates to heating, cooling or ventilation of transportation vehicle seats through the use of a heat source of the vehicle.

The transportation vehicle seats comprise at least one ventilated component such as a seat component, a backrest component, a bolster, an armrest, a headrest or the like. Each ventilated component may provide heating, cooling, ventilation or combinations thereof to the occupant, and comprises a seat cushion and a trim surface to cover the seat.

The heat source may be passive and is preferably waste energy produced by the vehicle. For example, engine heat from the engine block, the catalytic converter or other engine parts may be utilized as the heat source. Alternately, heat from the exhaust system may be utilized such as from the exhaust manifold or the exhaust pipes. In another embodiment, environment energy may be the heat source. For example, heat produced by sunlight or other environmental heating may be used.

In addition to the passive heat sources discussed above, the heat source may also be an active heat source in that it comprises a heating element that is powered by a power source (e.g. alternators, batteries, fuel cells, thermoelectric devices, solar cells, or the like). If such a power source is utilized, it preferably produces power through the conversion of waster or environmental energy to electricity; for example, a thermoelectric device that converts heat to electricity or a solar cell that convert light to electricity.

The present invention comprises an absorption refrigeration system to provide warm or cool sensation to the occupant of the vehicle seat. In one embodiment, this may be accomplished through the circulation of a temperature conditioned fluid from the system to the vehicle seat. In another embodiment, this may be accomplished through conductive cooling or heating of the vehicle seat itself.

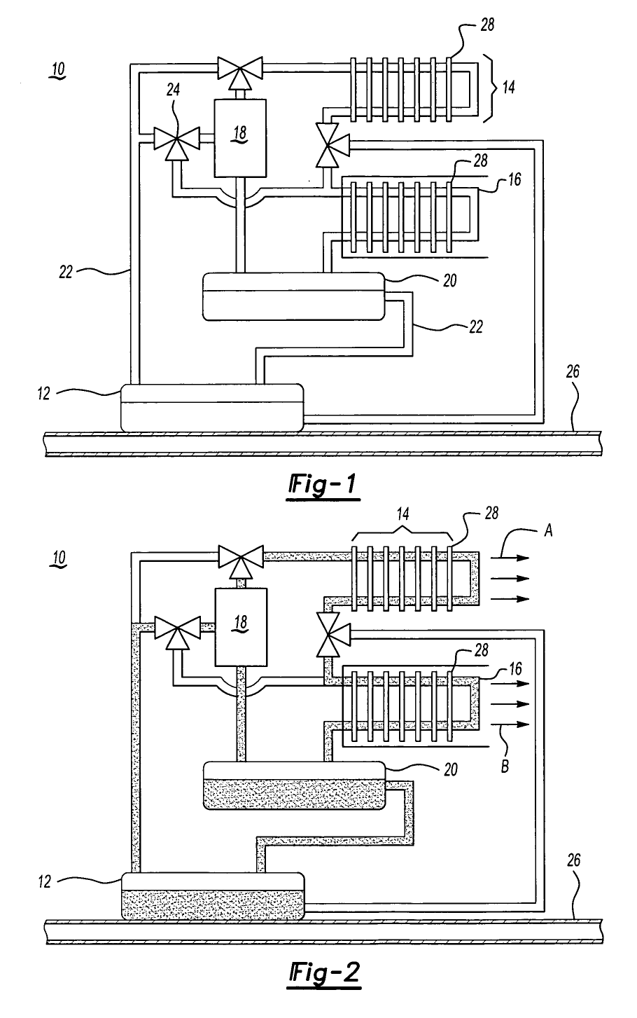

As seen in the embodiment of FIG. 1, the absorption refrigeration system 10 comprises a refrigerant in a closed system comprising a boiler 12, a condenser 14, and an evaporator 16. In a particular embodiment using a water-ammonia refrigerant, the system also comprises a refluxer 18 and an absorber 20. A variety of conduits 22 are used to connect the components of the system. One or more valves 24 may also be included in the absorption refrigeration system to switch between the various cycles discussed below. The boiler is placed in thermal contact with a heat source 26, such as a component of the exhaust system. One or more heat sinks 28 may be used on the condenser or evaporator.

In a cooling cycle, the waste or environment energy vaporizes the refrigerant in the boiler. The vaporized refrigerant travels to a condenser, which in turn provides liquid refrigerant to an evaporator. The evaporator, using a reduce pressure, again vaporizes the refrigerant, absorbing energy from fluid in contact with the evaporator (e.g. air) or from the seat material in contact or adjacent to the evaporator (e.g. seat cushion). The refrigerant then returns to the boiler. In the water-ammonia refrigerant embodiment, the refluxer separates the water from the ammonia, thus providing dry ammonia vapor to the condenser and water to the absorber. The absorber is utilized to recombine ammonia and water after the ammonia has exited the evaporator before returning the water-ammonia refrigerant to the boiler. FIG. 2 shows the cooling cycle of the system utilizing the water-ammonia refrigerant with Arrows A depicting air flow around the condenser and Arrows B depicting temperature conditioned fluid flow to the seat.

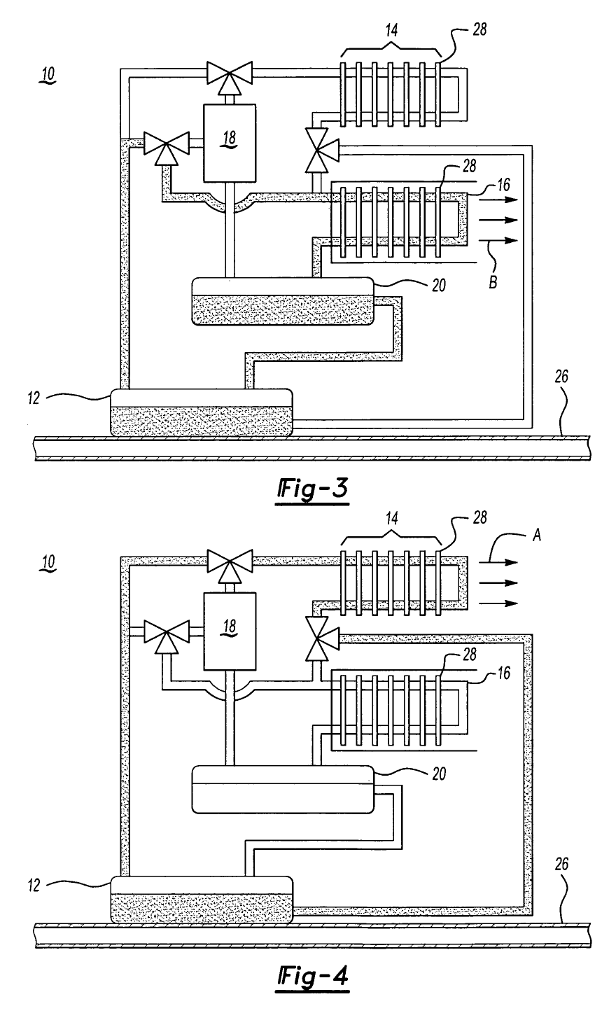

In a heating cycle, the refrigerant travels from the boiler to the evaporator where the refrigerant releases its energy to fluid in contact with the evaporator (e.g. air) or to the seat material in contact or adjacent to the evaporator (e.g. seat cushion). FIG. 3 shows the heating cycle of the system utilizing the water-ammonia refrigerant with Arrows B depicting temperature conditioned fluid flow to the seat.

In addition to the cooling and heating cycles, an idle cycle may also be used when neither cooling nor heating are required, as shown for the water-ammonia refrigerant embodiment in FIG. 4, with Arrows A depicting air flow around the condenser. In the cooling, heating and idle cycles, the surrounding fluid that has been temperature conditioned may be provided as is to the vehicle seat or it may be combined with non-temperature conditioned fluid (e.g. ambient air) or otherwise conditioned (e.g. dehumidified) or filtered (e.g. through a particle filter) before, during or after the temperature conditioned fluid is provided to the seat.

The boiler is preferably placed in thermal contact with a heat source of the vehicle. For example, the boiler may be in contact with the heat source or merely held adjacent to the heat source. A thermal conductor (e.g. a thermally conductive adhesive) may be used to separate the boiler from the heat source. A thermal insulator, while not preferred, may nonetheless also be used to separate the boiler from the heat source. Insulation around the boiler may be use to increase the efficiency of energy transferred from the heat source to the boiler or to otherwise separate the boiler from other components of the absorption refrigeration system or the vehicle.

In the embodiment using the vehicle exhaust system as the heat source, the boiler may be placed adjacent to and preferably in contact with one or more of the components of the exhaust system (e.g. exhaust manifold or exhaust pipes), and thus preferably not in the passenger compartment of the vehicle. In one aspect, the boiler may be integral with one or more components of the exhaust system. In this way, the boiler may be exposed to the hot gasses being exhausted by the engine leading to potentially better energy transference from the exhaust system to absorption refrigeration system.

Similarly, for the embodiment using the vehicle engine as the heat source, the boiler may also be placed in the engine compartment adjacent to or in contact with an engine component that produces heat. The boiler may be placed so as to use other vehicle components as heat sources such as components of the transmission system (e.g. the braking system).

For the embodiment utilizing an environmental heat source, the boiler may be placed in the passenger compartment, hood, trunk or frame of the vehicle or, preferably, in the roof of the vehicle. Preferably, the boiler is not visible to the vehicle passengers or does not otherwise adversely affect the size and shape of the passenger compartment. Such an environmental heat source may have its energy absorbing qualities enhanced through colorization. For example a dark paint may be selectively used on the roof over where the boiler is located, while other portions of the roof may have a light paint. Of course, a dark color paint may be used over the entire vehicle.

An active heat source would permit greater latitude in placement of the boiler permitting the boiler to be placed where ever it is convenient, but typically outside the passenger compartment.

The shape and size of the boiler is not critical as it may be shaped to address packaging concerns within the vehicle or increase the thermal contact between the boiler and the heat source. For example, the boiler may be tubular to fit around an exhaust pipe or relatively planar to fit between the header and the roof. The material of the boiler is not critical but preferably comprises a material that is thermal conductive adjacent to the heat source.

Insulation around the boiler may be use to increase the efficiency of energy transferred from the heat source to the boiler or to otherwise separate the boiler from other components of the absorption refrigeration system or the vehicle.

The condenser is located to facilitate heat loss to cause the refrigerant to liquefy. The condenser may be located in air stream created by the vehicle. Preferably, the air stream is created when the vehicle is in motion. As such, the condenser may be located on the underbody of the vehicle, in or near the roof, hood or trunk, or adjacent to the radiator. Further, the condenser is preferably located in thermal contact with a heat sink.

As with the boiler, the shape and size of the condenser is not critical, but these characteristics may be selected to address packaging concerns. The material of the condenser is preferably a thermally conductive material.

The evaporator is located in thermal contact with the vehicle seat. In one embodiment, the evaporator is placed to facilitate movement of a temperature conditioned fluid from the evaporator to the vehicle seat. Preferably, the evaporator is located within the passenger compartment of the vehicle, and more particularly, underneath or within the seat. By locating the evaporator in or near the seat, the distance that the fluid has to move to heat or cool the seat is reduced. In one embodiment, a fluid mover (e.g. an air mover or the like) is utilized to move the temperature conditioned fluid from the evaporator to the seat. In another embodiment, the evaporator is placed in the seat or backrest component (e.g. in the cushion) of the seat so that the seat may be cooled or heated through conduction and in the absence of a fluid mover.

The evaporator may utilize an expansion device such as a capillary tube, orifice, thermal expansion valve or the like to vaporize the refrigerant thus absorbing heat from the surrounding during the cooling cycle.

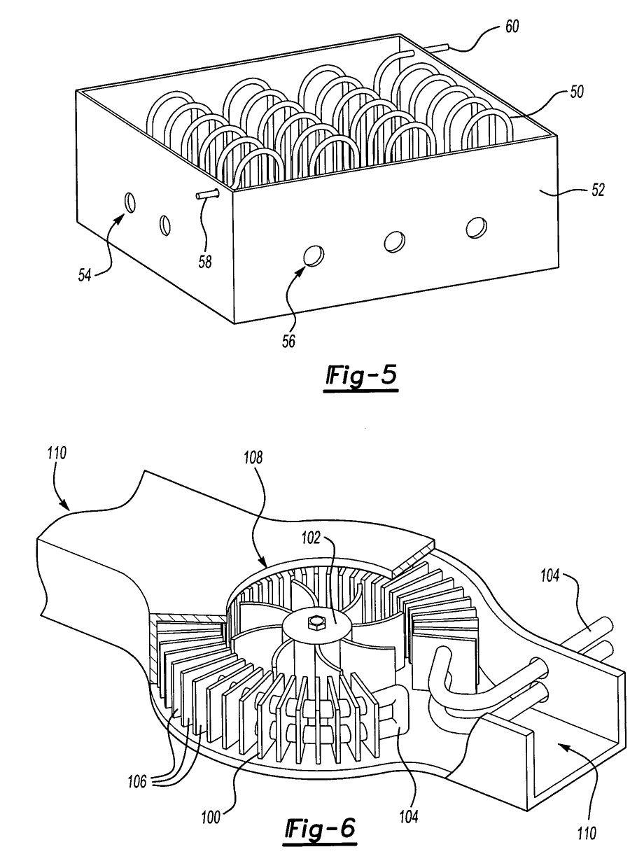

The evaporator contains conduit that facilitates the absorption or release of heat. For example, the conduit may be made of a thermally conductive material such as copper. Furthermore, the conduit may be shaped and sized so as to increase the surface area of the conduit exposed to the fluid being temperature conditioned while limiting the overall packaging size of the evaporator. As seen in one embodiment shown in cut away in FIG. 5, a sinusoidal conduit 50 may be used in an evaporator 52 to temperature condition air. Air is blown or drawn through inlets 54, across the conduit and out through the outlets 56. The refrigerant is passed through the conduit from the inlet 58 from the condenser and to the outlet 60 and to the boiler or other downstream components. The particular placement of the air inlets and outlets and the refrigerant inlets and outlets is not critical.

In one embodiment, as seen in FIG. 6, the evaporator 100 is combined with an air mover, such as a radial fan 102 into a component. The conduit 104 traverses a circumference of the radial fan and comprises a heat sink, such as a plurality of fins 106, to facilitate absorption or release of heat energy. Refrigerant flows from the condenser through the conduit and to the absorber or boiler, while air is drawn through an inlet 108. The air is then blown or drawn across the conduit and fins and directed to one or more outlets 110, which provide the temperature conditioned air to the vehicle seat. In this embodiment, the inlets and outlets for the air are relative; reversing the direction of the fan would reverse the direction of air flow in the evaporator-fan combination. One benefit of this embodiment, is the relatively compact packaging of the evaporator and fan that may permit the evaporator-fan combination to be located within the vehicle seat, such as within the seat or backrest component (e.g. in the seat cushion).

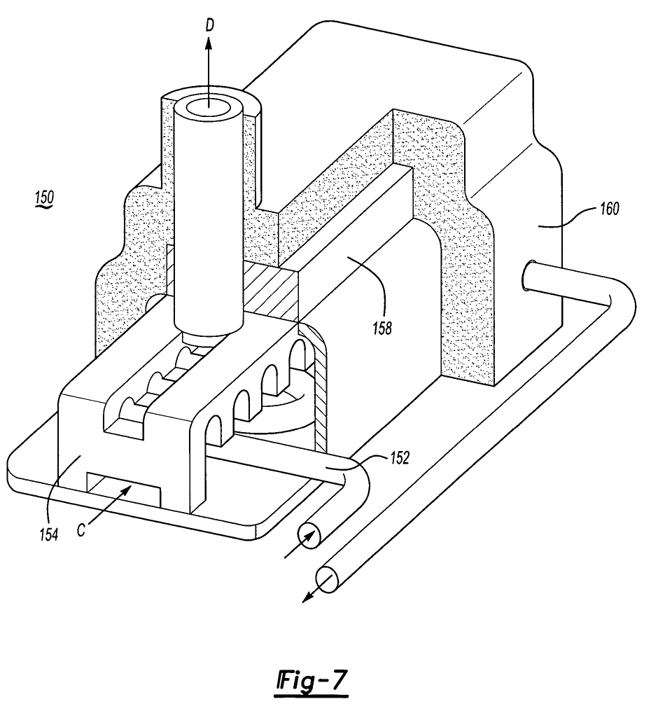

The evaporator may also comprise one or more cold accumulators for the purpose of cold storage or one or more heat sink to facilitate heat absorption or release. Preferably, the evaporator comprises insulation to increase the efficiency of the energy transfer from the refrigerant to the surrounding fluid. As seen in one embodiment in FIG. 7, the evaporator 150 comprises a conduit 152 located adjacent to a heat sink 154. Adjacent to the heat sink is a cold accumulator 158. Air is blown or drawn (shown by Arrow C) across the conduit, the heat sink and/or the cold accumulator to temperature condition the air, which is then directed toward the seat (shown by Arrow D). Insulation 160 is used to surround the evaporator and the other components.

Suitable refrigerants besides the preferred water and ammonia mixture include a circulating material that undergoes a phase change to promote the absorption and release of heat energy such as one or more hydrofluorocarbons, such as CH₃CHF₂, C₂HF₅, CH₂F₂, C₂H₃F₃, CHF₃ and C₂H₂F₄ including R-152a, R-125, R-32, R-143a, R-23 and R-134a. Hydrocarbons, such as propane, butane, pentane, may also be used as refrigerants. Combinations of refrigerants may also be used, as well as combinations of refrigerants and lubricants. Of course, selection of the refrigerant may necessitate the inclusion or permit the exclusion of components of the absorption refrigeration system discussed herein. For example for hydrofluorocarbon and hydrocarbon refrigerants, refluxers and absorbers may not be necessary. In addition, a compressor may be included in the system.

Material selection of the conduits and valves may depend on the compatibility with the selected refrigerant, based on cost, weight or durability considerations or combinations thereof.

Heat sinks discussed herein may include both air-cooled heat sinks such as stamped, extruded, casted, bonded/fabricated fins, corrugated folded fins or the like made of a suitable metal such as copper, bronze or aluminum. In addition, heat sinks including vapor phase change (e.g. refrigeration or heat pipes) may also be used as well as thermoelectric devices. Furthermore, heat sinks may comprise one or more of the metal components of the vehicle that do not usually heat during vehicle operation, such as the metal components of the vehicle frame or transmission.

The absorption refrigeration system may be incorporated into a larger seat system for providing heating, cooling, ventilation, etc. to a vehicle occupant by way of the occupant's seat. Several such systems are known and the present absorption refrigeration system may be used as an additional component of such systems or they may be used as a substitute for one or more of the components of such systems.

For example, the refrigeration absorption system may be added on to the seats of U.S. Pat. Nos. 6,786,541; 6,629,724; 6,840,576, 6,869,140, and related applications and patents or to the seats of U.S. Patent Publication 2004-0189061. In addition, the refrigeration absorption system may used in combination with the seats of U.S. Pat. Nos. 6,893,086; 6,869,139; 6,857,697; 6,676,207; 6,619,736; 6,604,426; 6,439,658; 6,164,719; 5,921,314, and related applications and patents, or U.S. Patent Publications 2005-0173950; 2005-0161986; 2005-0140189; 2005-0127723; 2005-0093347; 2005-0085968; 2005-0067862; 2005-0067401; 2005-0066505; 2004-0169028, and related applications. All patents and publications are hereby incorporated by reference.

The seat system comprises at least one of a seat or backrest component, having a seat cushion and a trim surface, with the seat system also comprising the absorption refrigeration system. In one embodiment, the evaporator is located in or adjacent to the component and provides conductive heating or cooling to the component (e.g. the cushion) and thus the occupant. In such an embodiment, a fan for providing temperature conditioned fluid to the seat may not be necessary to affect the desired temperature control of the seat. A fan may be used as part of the absorption refrigeration system (e.g. at the condenser) or to provide movement of ambient air to or from the seat to the occupant.

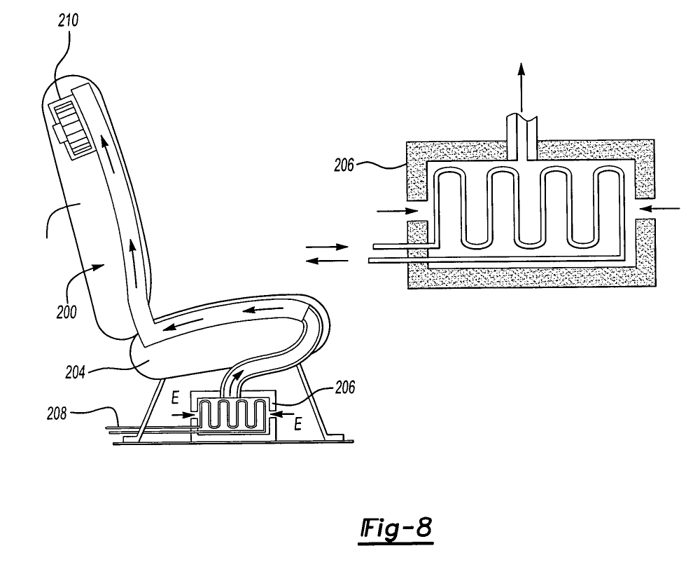

Other embodiments utilize a fan to provide temperature conditioned fluid from the evaporator to the seat. For all absorption refrigeration systems that provide temperature conditioned air, the air may be used convectively or conductively heat or cool the seat or occupant. As seen in FIG. 8, a vehicle seat 200 may comprise both a backrest component 202 and a seat component 204 fluidly connected to an evaporator 206 located underneath the seat. In this embodiment, air (Arrows E) is drawn across the conduit 208 of evaporator and into the seat by a fan 210.

In one embodiment, temperature conditioned air may be blown across the occupant through a permeable trim surface from the seat cushion thus providing convective heating or cooling to the seat and occupant. As shown in U.S. Pat. Nos. 6,869,139 and 6,857,697, the cushion may contain a passageway through the cushion for circulating temperature conditioned air to the seat surface. A variety of other optional features disclosed in these patents may be included in the seat systems of the present invention, such as sub-passageways, deflectors, air-impermeable linings or coating or the like. Moreover, a foam insert with through-holes may be placed over the sub-passageways to moderate or direct the air blown on the occupant. A certain amount of conductive cooling may also be achieved through the use of this system.

In another embodiment, conductive heating or cooling may be provided to the occupant by providing temperature conditioned air to the seat such that the air is not blown across the occupant. For example, through the use on an air impermeable trim surface, temperature condition air is circulated underneath the trim surface through passageways or sub-passageways in the cushion. Alternately, an insert having an open space is located underneath the impermeable trim surface, with air blown or drawn into the insert for the purpose of conductively heating or cooling the insert and thus the occupant. Suitable inserts include those depicted in U.S. Pat. Nos. 6,629,724; 6,840,576, 6,869,140 and 6,893,086.

In another embodiment, conductive and convective heating or cooling may be provided to the occupant. The temperature conditioned air from the evaporator may be combined with ambient air drawn across the occupant and into the seat. Here, ambient air is drawn through the trim surface and into a mixing region underneath the trim surface where the ambient air is combined with the temperature conditioned air. The mixed air is then circulated away from the seat either to be exhausted or to be recirculated back to the evaporator and/or the mixing region. The ambient air provides convective cooling (or heating), while the temperature conditioned air provided conductive cooling or heating. A plurality of air movers may be used to draw ambient air into the mixing region and to provide temperature conditioned to the mixing region, whether by blowing or drawing.

In one embodiment, the mixing region is an open space contained in an insert. Examples of seats comprising mixing regions include U.S. Patent Publication 2005-0067862 and 2005-0066505.

In another embodiment, the evaporator/ fan combination discussed above may be located in or adjacent to the cushion, as shown in FIG. 6. Such a combination of evaporator and fan may also be remote from the cushion, but preferably is located in or adjacent to the component to facilitate reduction in the packaging size of the seating system. Here, the temperature conditioned air produce by the evaporator-fan combination may be blown to the seat where it blown across the occupant, blown or drawn through an insert or combined with ambient air.

In addition, the absorption refrigeration system may be combined with other systems or devices to provide temperature regulation to an occupant. For example, heating elements may be utilized to provide heating to the vehicle seat, thus allowing the absorption refrigeration system to focus on providing only cooling to seat. Such an arrangement may permit the packaging size and power of the absorption refrigeration system to be reduced. In one embodiment, the heating element is provided between the trim surface and the seat cushion or insert of the seat. While not preferred but still acceptable, thermoelectric devices may be used to provide heating or cooling to the vehicle seat, particularly if the thermoelectric device is otherwise utilized in the vehicle and generates waste energy that may be recaptured for use in temperature control of the seat.

The present invention also relates to methods of heating, cooling and ventilating a vehicle seat. The method comprises circulating a refrigerant heated by a heat source of the vehicle, where the refrigerant is circulated through a closed system comprising a condenser and an evaporator. The method also comprises temperature conditioning a material in thermal contact with the evaporator such a seat component or a fluid that is then provided to the vehicle seat.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. A ventilated seat for a vehicle, comprising:
a vehicle seat comprising at least one ventilated with a seat cushion and a trim surface; and
an absorption refrigeration system comprising:
a boiler located in thermal contact with a heat source of the vehicle
a condenser;
an evaporator located in thermal contact with the vehicle seat;
a conduit fluidity connecting each of the boiler, condenser and evaporator to each other; and
a refrigerant located in the conduit.

2. The seat of claim 1 wherein the evaporator is located in thermal contact with the seat cushion of the ventilated component.

3. The seat of claim 2 wherein the trim surface is air impermeable.

4. The seat of claim 1 wherein the evaporator is located in thermal contact with a fluid transported from the evaporator to the ventilated component.

5. The seat of claim 4 wherein the fluid is air and further comprising an air mover.

6. The seat of claim 5 wherein the air mover is a radial fan and the evaporator and the fan are combined into an evaporator-fan component.

7. The seat of claim 6 wherein the evaporator-fan component is located within the seat cushion of the ventilated component.

8. The seat of claim 1 wherein the refrigerant is a composition comprising ammonia and water and the refrigeration absorption system further comprises a refluxer located between the boiler and the condenser and an absorber located between the evaporator and the boiler.

9. The seat of claim 1 wherein the evaporator further comprises a cold accumulator.

10. The seat of claim 1 wherein the heat source is a passive heat source.

11. The seat of claim 10 wherein the heat source is a waste heat source.

12. The seat of claim 11 wherein the waste heat source is a component of the engine or the exhaust system.

13. The seat of claim 10 wherein the heat source is an environment heat source.

14. The seat of claim 1 wherein the ventilated component is a seat component or a backrest component.

15. A ventilated seat for a vehicle, comprising:
a vehicle seat having a ventilated component selected from a seat component and a backrest component, at least one of which provides a seat cushion, a trim surface;
an air mover; and
an absorption refrigeration system comprising:
a boiler located in thermal contact with a waste heat source of the vehicle;
a condenser located in an air stream of the vehicle;
an evaporator in contact with air to provide temperature conditioned air;
a conduit fluidity connecting each of the boiler, condenser and evaporator to each other; and
a refrigerant located in the conduit,
wherein the air mover transports the temperature conditioned air to the ventilated component.

16. The seat of claim 15 wherein the trim surface is an air impermeable trim surface.

17. The seat of claim 15 wherein the temperature conditioned air is blown across a seat occupant.

18. The seat of claim 15 wherein the temperature conditioned air is combined with ambient air in a mixing region of the ventilated component.

19. The seat of claim 18 further comprising a heating element located beneath the trim surface.

20. A ventilated seat for a vehicle, comprising:
a vehicle seat having a ventilated component selected from a seat component and a backrest component, at least one of which provides a seat cushion, an air mover, an insert, an air permeable trim surface and a heating element located between the trim surface and the insert;
an absorption refrigeration system comprising:
a boiler located in thermal contact with a waste heat source of the vehicle;
a condenser located in an air stream of the vehicle;
an evaporator in contact with air to provide temperature conditioned air;
a conduit fluidity connecting each of the boiler, condenser and evaporator to each other; and
an ammonia and water refrigerant located in the conduit,
wherein the air mover transports the temperature conditioned air to the insert and is combined with ambient air.
